(19) United States
(12) Patent Application Publication
(10) Pub. No.: US 2005/0251478 A1
(43) Pub. Date: Nov. 10, 2005

(54) Investment and method for hedging operational risk associated with business events of another

(76) Inventor: Aura Yanavi, Clifton, NJ (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/947,931

(22) Filed: Sep. 23, 2004

Related U.S. Application Data
(60) Provisional application No. 60/568,077, filed on May 4, 2004.

(51) Int. Cl. G06F 17/60

(52) U.S. Cl. 705/40

(57) ABSTRACT

An investment and a method for hedging operational risk associated with another's business events is disclosed. In particular, the method includes a seller receiving consideration from a buyer and, in return for the consideration, making a payment to the buyer upon the occurrence of a predetermined event. The event payment is for a predetermined amount and may be related to an expected economic loss to the buyer if the predetermined event occurs. The predetermined event is related to a complete or partial success or failure of a reference entity's product, service, or product and service, and may or may not cause an economic loss to the buyer.

### Cross-Reference to Related Application

This application claims the benefit of U.S. Provisional Application No. 60/568,077, filed May 4, 2004, the entire disclosure of which is hereby incorporated herein by reference.

### FIELD OF THE INVENTION

This invention relates to hedging the operational risk associated with another's business events. In particular, this invention pertains to hedging against a risk of loss due to a reference entity's product, service, or product and service, failing, in whole or in part, in a given market. Additionally, this invention pertains to investing in the potential for a reference entity's product, service, or both, to fail or succeed, in whole or in part in a given market, where the investor has no operational risk in such a product, service, or both.

### BACKGROUND OF THE INVENTION

Companies are commonly involved in business relationships with other companies. For instance, “Company A” may use the services of “Company B,” incorporate the products of Company B into its own products, or have some other interest in Company B's products, services, or both. Such interest may expose Company A to a potential economic loss if Company B's products, services, or products and services, fail in some meaningful way.

Conventionally, companies like Company A have accepted such risks as the costs of doing business, because there are no effective alternatives. In the case where Company A and Company B have a business relationship, there is no current instrument which allows Company A to insure itself against an economic loss due to the failure of Company B's products, services, or both. Company A may seek contractual provisions from Company B to protect against economic losses caused by this failure. However, such provisions are limited to the extent contracted for up to the financial health of Company B, either of which may not cover the entire loss suffered by Company A.

Therefore, there is a need in the art for an effective solution to provide for the situation where a company seeks to fully protect itself from the risk associated with the failure of another company's products, services, or both.

### SUMMARY OF THE INVENTION

This problem is addressed and a technical solution is achieved in the art by an investment and a method for hedging the operational risk associated with business events of another. According to one embodiment of the invention, the method includes receiving consideration from a buyer and, in return for the consideration, making an event payment to the buyer upon the occurrence of a predetermined event related to a failure of a reference entity's product, service, or product and service. The event payment is for a predetermined amount and may be related to an expected economic loss to the buyer if the event occurs. The received consideration also may be related to the expected loss to the buyer and may take the form of a periodic payment. The predetermined event optionally may cause an economic loss to the buyer. Additionally, occurrence of the predetermined event may be controlled by a third party that issues quality ratings or certifications. By allowing a buyer to receive payment upon the failure of a reference entity's product, service, or product and service, the buyer may reduce the risk of economic loss due to such failure.

According to this embodiment, the combination of receiving consideration and making a payment upon the occurrence of the predetermined event may be executed within the context of an agreement having a financial value. In this scenario, the method includes transferring the agreement to another party, where the other party makes the event payment to the buyer upon the occurrence of the predetermined event. Advantageously, information regarding the agreement may be incorporated into a data processing system. By transferring the agreement to another party, risk associated with the obligation to pay the buyer upon the occurrence of the predetermined event, is also reduced.

A second embodiment of the invention provides an investment in a success or failure of a reference entity's product, service, or product and service. According to this embodiment, the buyer may have no relationship with the reference entity and need not experience an economic loss upon the occurrence of the predetermined event. The buyer may be an inventor that wants to invest in the potential for the reference entity's products, services, or both, to succeed or fail. This investment preferably is freely transferable and implemented as a “swap” agreement, which allows a market value to develop regarding the quality of a company's products, services, or both. Advantageously, the information associated with the investment may be incorporated into a data processing system.

### BRIEF DESCRIPTION OF THE DRAWINGS

A more complete understanding of this invention may be obtained from a consideration of this specification taken in conjunction with the drawings, in which:

FIG. 1 is a block diagram illustrating the exemplary embodiments of the present invention;

FIG. 2 is a flow chart illustrating the process flow according to the first exemplary embodiment; and

FIG. 3 is a flow chart illustrating the process flow according to the second exemplary embodiment.

### DETAILED DESCRIPTION OF THE EXEMPLARY EMBODIMENT(S) OF THE INVENTION

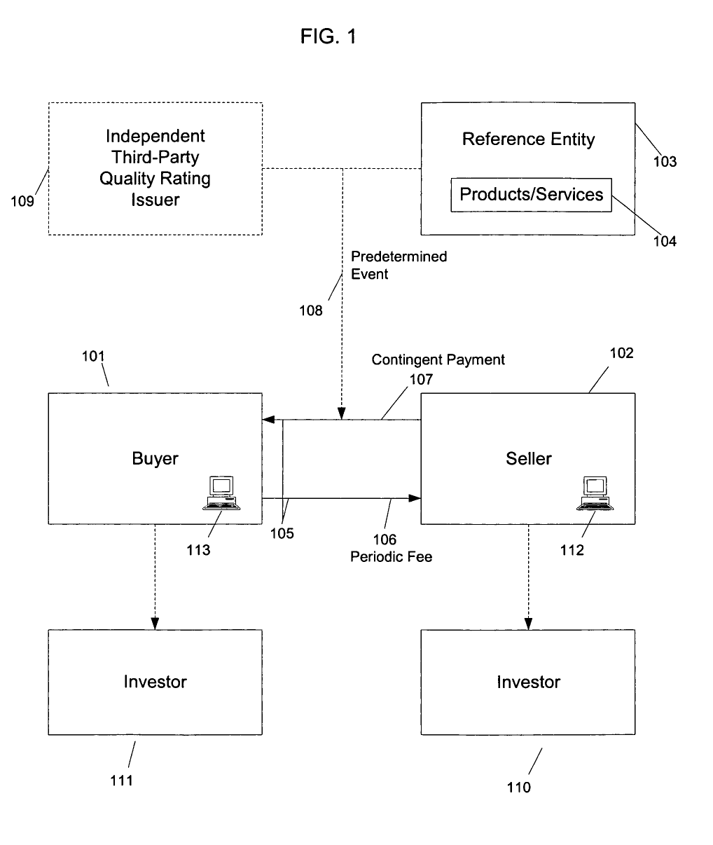

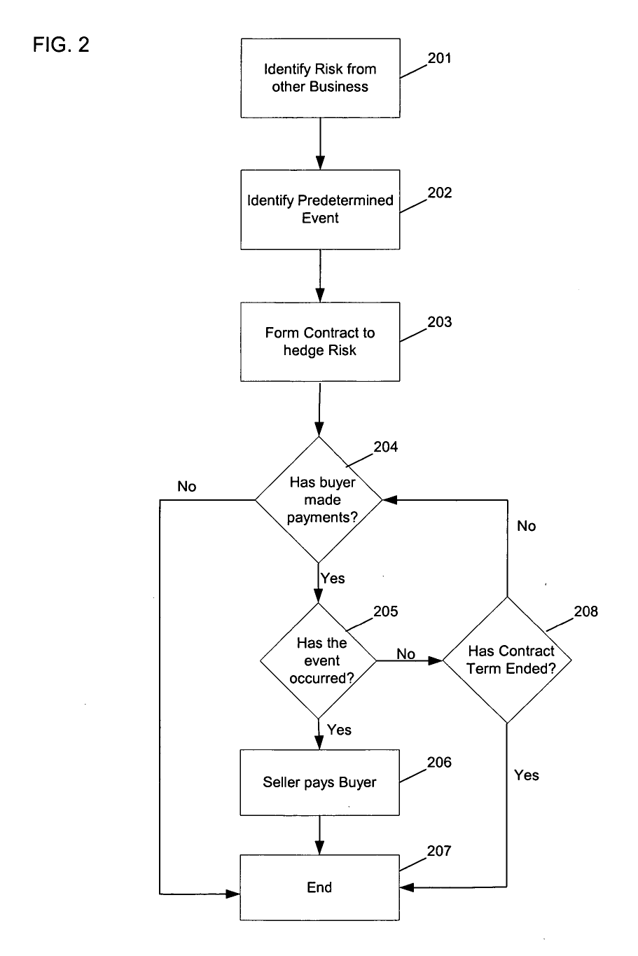

A first embodiment of the present invention will be described with reference to FIGS. 1 and 2, in which a bilateral financial contract 105 is formed between a buyer 101 and a seller 102. Buyer 101 is any entity, whether an individual or otherwise, having an interest in a reference entity's 103 product, service, or product and service 104 failing, in whole or in part. The terms “failing,” “failure,” and “fail” used throughout this specification are intended to include any defined complete or partial negative event occurring with respect to a reference entity's 103 product, service, or both. For instance, a failure of a product may include the abandonment of a product line or a reduction in quantities sold over a period. A failure of a product may also include the failure of meeting expected sales growth rates. An example of a failure of a service may include cessation of the offering of the service or a mistake in the offering of the service that results in a successful lawsuit.

Exemplary buyers in FIG. 1 include, but are not limited to, companies who use reference entity's 103 services 104, incorporate reference entity's 103 products 104 into their own products, or have some other interest in the operation of reference entity's 103 products, services, or both 104 on the market.

Likewise, reference entity 103 may be any entity in which buyer 101 has an interest in the failure of reference entity's 103 products, services, or both 104. Exemplary reference entities 103 include, but are not limited to, companies who provide buyer 101 with their products, services, or both 104, or have no direct relationship with buyer 101, except that buyer 101 has an interest in the failure of reference entity's 103 products, services, or both 104. Seller 102 is any entity who desires to acquire a risk in return for increased expected returns. Exemplary sellers include, but are not limited to, banks, hedge funds, insurance companies, asset managers, or securities firms.

The bilateral contract 105 requires that the buyer 101 offer some sort of consideration 106 to the seller 102 in return for an event payment 107 contingent upon the occurrence of a predetermined event 108. The predetermined event 108 is related to a failure of the reference entity's 103 product, service, or product and service 104, and causes an economic loss to the buyer 101. In other words, according to the first embodiment, buyer 101 and reference entity 103 have some sort of business relationship such that buyer 101 is exposed to economic loss if the reference entity's products, services, or both, fail. Event payment 107 is the total amount (“notional amount”) purchased by buyer 101 from seller 102. The event payment 107 is a predetermined amount and may be related to an expected economic loss to the buyer 101 if the predetermined event 108 occurs. Consideration 106 may be a periodic fee (“premium”) expressed as a percentage of the notional amount 107 purchased by buyer 101 from seller 102. For instance, if buyer 101 and seller 102 agree to provide buyer 101 with $100,000,000 in return for 0.4% of the notional amount 107 each year, buyer 101 owes $400,000 each year to seller 102. If the periodic fee 106 is made on a quarterly basis, buyer 101 owes seller 102 $100,000 each quarter. One skilled in the art would appreciate, however, that consideration 106 may be provided in other forms, such as a one-time fee, or anything else of value.

One category of relationships between buyer 101 and reference entity 103 is buyer's 101 involvement with reference entity's 103 products 104. In this context, exemplary events 108 that trigger contingent payment 107 include, but are not limited to, a voluntary or involuntary product recall, a successful product liability claim, failure to obtain government approval for a product such as failing to obtain a patent or FDA approval, a revocation of government approval (e.g., a finding of patent invalidity), or a poor or downgraded product quality rating issued by an independent third party 109.

As an example, assume buyer 101 is an automobile manufacturer, reference entity 103 is a tire manufacturer, and buyer 101 installs reference entity's 103 tires (reference numeral 104 in this example) on its automobiles. Also assume that buyer 101 wants to protect itself from the operational risk that the tires made by reference entity 103 are defective, because if the tires are defective, buyer 101 would be exposed to tremendous losses. Accordingly, buyer 101 enters into contract 105 with seller 102, where buyer 101 pays seller 102 a periodic fee 106 as previously described. If it turns out that the tires made by reference entity 103 rupture at high speeds at a high temperature (i.e., the predetermined event 108 has occurred), the agreed-upon notional amount is paid from seller 102 to buyer 101, as shown at 107.

For another example in the product usage context, assume that buyer 101 is a licensee of one of reference entity's 103 patents (reference numeral 104 in this example). Buyer 101 enters into a contract 105 with seller 102 to protect against the risk that the patent is found to be invalid or unenforceable, which would be the predetermined event 108 in this example. Accordingly, buyer 101 pays seller 102 a periodic fee 106 in return for a lump sum payment (reference numeral 107 in this example) if the predetermined event 108 occurs.

Another category of relationships between buyer 101 and reference entity 103 is buyer's 101 involvement with reference entity's 103 services 104. In this context, exemplary events 108 that trigger contingent payment 107 include, but are not limited to, situations where buyer 101 uses the services of reference entity 103 and wants protection against failure of that service. In particular, these exemplary events 108 include, without limitation, situations where reference entity 103 is an independent contractor performing work for buyer 101, and buyer 101 wants to hedge against the risk that reference entity 103 will fail in its performance.

As an example, assume buyer 101 is having reference entity 103 install a critical computer system. Although buyer 101 has confidence in reference entity 103, buyer 101 may want to hedge against the risk of significant losses if reference entity 103 fails to install the system in a timely manner. Hence, the predetermined event 108 in this example is failure to install the system by a certain date. Accordingly, buyer 101 may enter into contract 105 with seller 102 to hedge against this risk. If reference entity 103 fails to install the system by the certain date, seller 102 would pay the agreed-to payment 107 to buyer 101.

Yet another category of relationships between buyer 101 and reference entity 103 is when reference entity's 103 provision of products, services, or both 104, to buyer 101 is contingent upon reference entity's 103 receipt and maintenance of a process quality certification or rating. In this context, exemplary events 108 include, without limitation, failure to obtain, maintain, or meet process quality ratings or certifications including, without limitation, ISO 9000, ISO 14000, CMM, CMMi, and government certifications, such as safety or environmental standards.

For example, if reference entity 103 supplies buyer 101 with products, services, or products and services 104, and it turns out that reference entity 103 fails to comply with environmental regulations, reference entity 103 may be shut down. Accordingly, buyer 101 hedges against such risk by entering into contract 105 with seller 102 to protect against the predetermined event 108 that reference entity 103 fails to comply with such environmental regulations.

Still yet another category of relationships between buyer 101 and reference entity 103 is when buyer 101 has some financial interest in reference entity's 103 success, and wants protection against the risk that one of reference entity's 103 key products, services, or products and services 104 fails. For example, assume buyer 101 is a large shareholder in reference entity 103, which is pharmaceutical company. In this scenario, buyer 101 may want protection against the risk that reference entity's 103 key drug does not obtain FDA approval or patent protection, for example. Accordingly, buyer 101 may enter into contract 105 with seller 102 to obtain such protection.

The contract 105 of the first embodiment may be implemented as a“quality default swap” having a structure similar to a credit default swap known in the art, but affording a completely different type of protection. In particular, a credit default swap affords protection to a buyer from credit risk, whereas, the present invention may afford protection to a buyer from the operational risk associated with a reference entity's product, service, or both, failing in a given market, in whole or in part. Further, the market value of a credit default swap indicates the perceived strength of a reference entity's credit, whereas the market value of a quality default swap indicates the perceived strength of a reference entity's products, services, or both. Although contract 105 of the exemplary embodiment is implemented as a quality default swap, any contract 105 will suffice.

The process flow according to the first embodiment will now be described with reference to FIG. 2. At 201, the process begins with the buyer 101 identifying a potential risk of economic loss associated with the failure of another business's products, services, or products and services 104. Once the risk has been identified, an event 108 that will trigger such economic loss is defined at 202. With this information, buyer 101 enters into a contract 105 with seller 102 at 203. The contract 105 includes, at least, all of the terms previously described with reference to the quality default swap. For example, the contract includes terms defining the periodic premium payments 106 paid by the buyer 101 to the seller 102, the predetermined event 108, the duration term of the contract 105, and the amount to be paid 107 by seller 102 to buyer 101 upon the occurrence of the predetermined event 108.

After the contract 105 has been formed at 203, performance of the contract begins at 204. At 204, it is determined whether the buyer 101 has been current on its premium payments 106 to seller 102. According to the exemplary embodiment, if the buyer 101 has not fulfilled its obligation to pay premium payments 106, the contract 105 is terminated at 207 due to breach. If the buyer 101 has met its obligations at 204, it is determined whether the predetermined event 108 has occurred at 205. If so, the seller 102 pays the buyer 101 according to the contract 105 at 206, and the contract is terminated at 207. If the predetermined event 108 has not occurred at 205, it is determined whether the contract has reached maturity at 208. If so, the contract is terminated at 207. If the contract duration term has not expired at 208, the process returns to 204.

According to a second embodiment of the present invention, buyer 101 need not have any relationship with reference entity 103 prior to entering into contract 105. Buyer 101 is an investor interested, in a manner not explicitly described above, in the success or failure of reference entity's 103 products, services, or both 104. Since no relationship exists between buyer 101 and reference entity 103, buyer 101 is not seeking protection against the operational risk of doing business with the reference entity 103. Thus, prior to execution of the contract 105 in this situation, the buyer 101 need not be subject to a risk of economic loss if the predetermined event 108 occurs, but upon occurrence of the predetermined event 108, buyer 101 will receive event payment 107 even though no economic loss has occurred. In other words, buyer 101 is investing in the strength or weakness of the reference entity's products, services or both. Accordingly, the contract 105 is preferably implemented as a quality default swap and is a pure investment instrument open to any buyer 101. Consequently, the market value of such a quality default swap indicates the perceived strength or weakness of the reference entity's 103 product, service, or both 104.

The terms “succeeding,” “success,” and “succeed” used throughout this specification are intended to include any defined complete or partial positive event occurring with respect to a reference entity's 103 product, service, or both. For instance, a success of a product may include an award being granted for the product or an increase in quantities sold over a period. A success of a product may also include maintaining sales numbers or even losing less revenue than was expected. An example of a success of a service may include an exceptional rating being awarded for the service or offering the service over a period without any customer complaints.

When buyer 101 invests in the strength and quality of reference entity's 103 products, services or both 104, the risk to buyer 101 becomes whether the predetermined event 108 will occur at all. In this embodiment, the buyer 101 may reduce the risk associated with this transaction by advantageously transferring its right to receive the event payment 107 from the seller 102 and its obligation to provide consideration to seller 102 to another party, such as a separate investor 111. In such a case, seller 102 would pay the notional amount 107 to investor 111 upon the occurrence of the predetermined event 108, and, if a periodic fee is used as consideration 106, seller 102 would receive the periodic fee 106 from the investor 111. Similarly, seller 102 can transfer the rights and obligations it acquires under contract 105 to a party outside the contract, such as an investor 110 in FIG. 1. In such a case, the buyer 101 would be responsible for paying consideration 106 to investor 110, and would expect to receive the event payment 107 from investor 110 upon occurrence of the predetermined event 108.

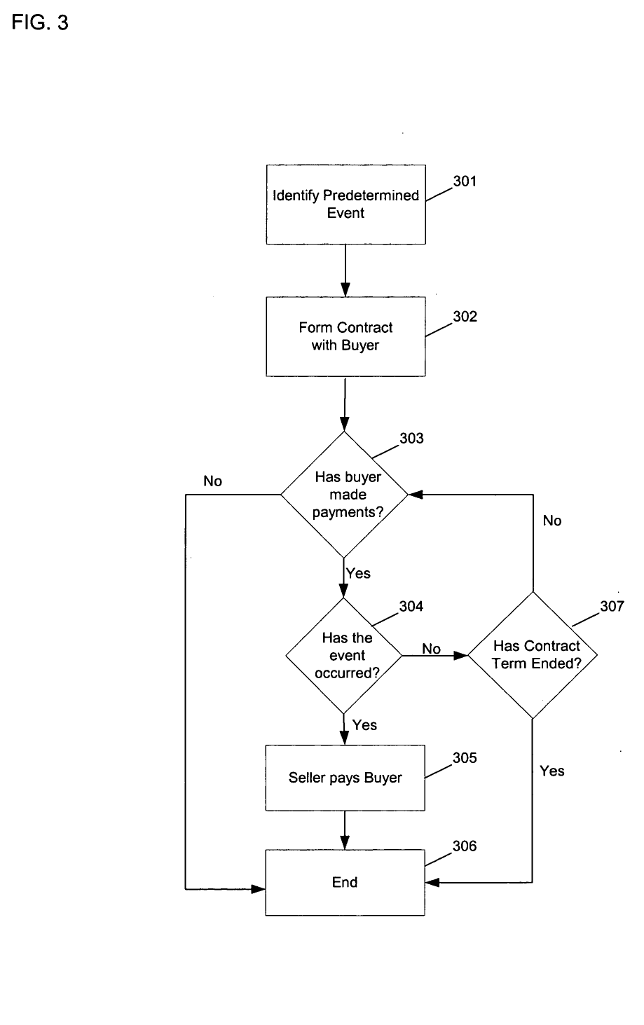

FIG. 3 describes the process flow according to the second embodiment and is very similar to the process described in FIG. 2. Because this investment need not pertain to a risk of an economic loss to buyer 101, the process begins at 301 with identifying a predetermined event 108 which is related to the success or failure of the reference entity's 103 products, services, or both 104, in a given market. Seller 102 then forms a contract 105, such as a quality default swap, with buyer 101, at 302. Since the contract 105 requires no relationship between buyer 101 and reference entity 103, the contract is a pure investment instrument with a market value and may be traded by both buyer 101 and seller 102 to other parties, such as investors 110 and 111.

The remaining steps of FIG. 3 mimic the process of FIG. 2 with determining whether buyer 101 is current on paying the periodic fee 106 to seller 102 at 303, and whether the predetermined event 108 has occurred at 304. If the buyer 101 is current on payments 106 and the event 108 has occurred, seller 102 will transmit event payment 105 to buyer at 305 and the contract is terminated at 306. The contract 105 may also be terminated when the contract either reaches maturity prior to the event at 307, or is breached due to buyer 101 defaulting on payments 106 at 303. Additionally, if either the buyer 101 or the seller 102 transfer the rights and obligations under the contract 105 to other investors 110 and 111, those investors become the “buyer” or “seller,” respectively, in the process.

Regarding both embodiments, implementing contract 105 as a swap allows a market value to develop regarding the success or failure of a reference entity's products, services, or both, and thus, expands the current market to include such transactions. Exemplary terms of the quality default swap 105 include, without limitation, general terms and payment terms. The general terms include the trade date; the date the trade becomes effective; the termination or maturity date; the identity of the seller 102, the buyer 101, and the reference entity 103; the particular product(s) or service(s) 104 involved; any quality rating or certification involved, such as those previously described; the identity of any other parties involved, such as a calculation agent; business date commencement, and accrual methodology.

Payment terms include information about the buyer's 101 fixed payment 106 and the seller's 102 floating payment 107. The fixed payment information includes the notional amount, the percentage of the notional amount to be paid per year, payment dates, and amount of payment on each of the payment dates. The floating payment information includes a description of the predetermined event 108 and the conditions for which payment 107 is to be made; the identity of any sources used to determine occurrence of the predetermined event 108, such as a third party 109; and the amount of payment 107 if different from the notional amount.

Quality default swap 105, according to the exemplary embodiments, also includes settlement terms, such as the settlement method (e.g., cash settlement) and currency. Additional terms include dispute resolution information and notice information. It may be advantageous to store the terms, conditions and any other information pertaining to contract 105, including the performance of contract 105, in a computer system, as referenced at 112 and 113, in FIG. 1.

It is to be understood that the exemplary embodiments are merely illustrative of the present invention and that many variations of the above-described embodiments can be devised by one skilled in the art without departing from the scope of the invention. For instance, the present invention is not limited to the ordering of the process flows shown in FIGS. 2 and 3. For example, identification of risk at 201 and identification of the predetermined event at 202 may occur simultaneously with contract formation at 203. Further, the determinations at 204, 205, and 208, and 303, 304, and 307, respectively, may occur in any order. It is therefore intended that all such variations be included within the scope of any following claims and their equivalents.

1. A method for investing comprising:
promising to pay an amount to a buyer upon occurrence of a predetermined event as part of an agreement, wherein the agreement defines the event as related to a complete or partial success or failure of a reference entity's product, service or product and service, and
receiving an obligation to provide value in return for said promise.

2. The method according to claim 1 wherein the agreement is a swap agreement having a financial value.

3. The method according to claim 2 further comprising transferring the agreement to a party wherein the party is obligated to pay the amount upon occurrence of the predetermined event to the buyer.

4. The method according to claim 3 wherein the party is entitled to receive the value from the buyer in exchange for the party's obligation to pay the amount.

5. The method according to claim 2 further comprising receiving a sum related to the financial value of the agreement in exchange for transferring the agreement to a party.

6. The method according to claim 2 further comprising promising to pay the amount to a party upon occurrence of the predetermined event wherein the party has purchased the agreement from the buyer.

7. The method according to claim 6 wherein the party is obligated to provide the value in exchange for said promise of the amount.

8. The method according to claim 1 wherein the buyer has a contractual relationship with the reference entity involving the reference entity's product, service, or product and service.

9. The method according to claim 8 wherein the predetermined event causes an economic loss to the buyer.

10. The method according to claim 9 wherein the amount is related to the economic loss to the buyer if the predetermined event occurs.

11. The method according to claim 1 wherein the value received is a periodic fee related to the amount.

12. The method according to claim 1 wherein the occurrence of the predetermined event is controlled by a third party that issues quality ratings or certifications.

13. The method according to claim 1 wherein information pertaining to the agreement is stored in a computer-readable memory.

14. A method for hedging against risk comprising:
identifying a risk associated with a complete or partial failure of a reference entity's product, service, or product and service, wherein the risk is an operational risk resulting from a business relationship with the reference entity, wherein the relationship involves the reference entity's product, service, or product and service;
identifying a predetermined event related to the complete or partial failure of the reference entity's product, service, or product and service, wherein the predetermined event causes an economic loss;
receiving a promise to pay an amount from a seller upon occurrence of the predetermined event, wherein the amount is related to the economic loss expected upon occurrence of the predetermined event, and
providing value to the seller in return for the received promise.

15. The method according to claim 14 wherein the providing value and the receiving the promise is provided in an agreement, wherein the agreement is a swap agreement having a financial value.

16. The method according to claim 15 further comprising providing value to a party wherein the party purchased the agreement from the seller.

17. The method according to claim 16 wherein the party is obligated to fulfill the promise of paying the amount upon occurrence of the predetermined event.

18. A method of investing related to a risk associated with a complete or partial success or failure of a reference entity's product, service, or product and service, the method comprising the step of entering into an agreement having at least two sides wherein:
consideration on one side of the agreement comprises a promise to pay an amount, wherein the payment is contingent upon the occurrence of a predetermined event related to the complete or partial success or failure of the reference entity's product, service or product and service, and
consideration on the other side of the agreement comprises an obligation to provide value for said promise.
